(19) United States
(12) Patent Application Publication
(10) Pub. No.: US 2019/0087541 A1
(43) Pub. Date: Mar. 21, 2019

(54) METHOD AND SYSTEM FOR STORING DATA DURING UPDATES OF ELECTRONIC MEDICAL RECORDS

(71) Applicant: Konica Minolta Healthcare Americas, Inc., Wayne, NJ (US)

(72) Inventor: Hiroyuki Kubota, Wayne, NJ (US)

(73) Assignee: Konica Minolta Healthcare Americas, Inc., Wayne, NJ (US)

(21) Appl. No.: 15/708,713

(22) Filed: Sep. 19, 2017

(51) Int. Cl. G06F 19/00

(52) U.S. Cl. CPC G06F 19/322

(57) ABSTRACT

A method for storing data during an update of an electronic medical record. The method includes obtaining, from a first source, first electronic medical record data to be written to a first data field of the electronic medical record, obtaining, from a second source, second electronic medical record data to be written to a second data field of the electronic medical record, and making a first determination that different data fields of the electronic medical record are targeted by the first and the second sources. The method further includes, based on the first determination, accepting the first and the second electronic medical record data in the first and the second data fields, respectively, of the electronic medical record to obtain a first updated electronic medical record.

### BACKGROUND

Electronic medical records, including medical images and other medical data play a crucial role in the diagnosis of patients. Healthcare facilities (e.g., hospitals) have realized the benefits of electronically storing medical records. The digitalization of medical images and other data not only enables users to easily access the medical images and medical data, but also enables the images and data to be easily shared between multiple healthcare facilities.

In the healthcare industry, the use of a system known as a Picture Archiving and Communications System (“PACS”) is becoming increasingly popular for convenient storage and access of medical images. Generally, a PACS comprises a multitude of devices working cooperatively to digitally capture, store, manage, distribute, and display medical images generated by various imaging modalities, such as computed tomography (CT), magnetic resonance imaging (MRI), position emission tomography (PET), ultrasound, X-ray, etc. PACS allows various healthcare facilities to share all types of images captured internally or externally.

More recently, cloud-based PACS have emerged as a way to improve efficiency and accessibility of traditional PACS. In general, a “cloud” can be understood as an online storage system that provides remote, on-demand access of computing resources and data over the Internet to multiple computers and devices in various locations. Cloud-based PACS may be provided by vendors who use remote or off-site data centers in various locations for storage of medical images.

The above-described concepts are not limited to image data. For example, any other type of medical data such as lab tests and results may be acquired, processed and stored in a similar manner. Generally speaking, the above-described concepts are applicable to any type of electronic medical records that may include any types of image data and/or any types of non-image data.

### SUMMARY

In general, in one aspect, the invention relates to a method for storing data during an update of an electronic medical record, comprising: obtaining, from a first source, first electronic medical record data to be written to a first data field of the electronic medical record; obtaining, from a second source, second electronic medical record data to be written to a second data field of the electronic medical record; making a first determination that different data fields of the electronic medical record are targeted by the first and the second sources, and based on the first determination: accepting the first and the second electronic medical record data in the first and the second data fields, respectively, of the electronic medical record to obtain a first updated electronic medical record.

In general, in one aspect, the invention relates to a non-transitory computer readable medium (CRM) storing instructions that cause a computing system to perform an operation to store data during an update of an electronic medical record, comprising: obtaining, from a first source, first electronic medical record data to be written to a first data field of the electronic medical record; obtaining, from a second source, second electronic medical record data to be written to a second data field of the electronic medical record; making a first determination that different data fields of the electronic medical record are targeted by the first and the second sources, and based on the first determination: accepting the first and the second electronic medical record data in the first and the second data fields, respectively, of the electronic medical record to obtain a first updated electronic medical record.

In general, in one aspect, the invention relates to a computing system that stores data during an update of an electronic medial record, the computing system comprising: a central server; and a central repository associated with the central server, wherein the central server: obtains, from a first source, first electronic medical record data to be written to a first data field of the electronic medical record; obtains, from a second source, second electronic medical record data to be written to a second data field of the electronic medical record; makes a first determination that different data fields of the electronic medical record are targeted by the first and the second sources, and based on the first determination: accepts the first and the second electronic medical record data in the first and the second data fields, respectively, of the electronic medical record to obtain a first updated electronic medical record.

### BRIEF DESCRIPTION OF DRAWINGS

FIG. 1 shows a schematic diagram of a system in accordance with one or more embodiments of the invention.

FIG. 2 shows an exemplary electronic medical record in accordance with one or more embodiments of the invention.

FIG. 3 shows an exemplary scenario that includes conflicting electronic medical record data in accordance with one or more embodiments of the invention.

FIG. 4 shows a flowchart illustrating a method for storing conflicting data during synchronization of electronic medical records in accordance with one or more embodiments of the invention.

FIG. 5 shows a flowchart illustrating a method for performing a conflict resolution in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency. Like elements may not be labeled in all figures for the sake of simplicity.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that, one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments of the invention may be combined with other dependent claims.

In general, one or more embodiments of the invention provide a method, a non-transitory computer readable medium and a system configured for updating and storing electronic medical records and for local-to-cloud synchronization of electronic medical records, including a mechanism for addressing conflicts that may occur during the updating and/or synchronization. A “conflict” generally may result from editing of an electronic medical record by multiple parties, which may cause a disagreement or incompatibility of data of the medical record. The cloud-based system, e.g., a PACS, in accordance with one or more embodiments of the invention enables all healthcare facilities that are given permission to access a cloud data repository or database (“cloud repository”), such as facilities within the same hospital group, to share medical images and/or other data. The medical images and/or other data may be stored in an electronic medical record. A healthcare facility would then be able to access and retrieve its patients' medical images and/or other data obtained at the other healthcare facilities that are “in-network” (i.e., having permission to access the same portion of the cloud repository). Specifically, according to one or more embodiments of the invention, in-network healthcare facilities can more effectively utilize the cloud-based PACS to share and update medical images and/or other data for patients who frequent multiple of the in-network healthcare facilities (i.e., a shared or common patient between two or more in-network healthcare facilities). Conflicting data may occur, for example, when an electronic medical record is accessed by two healthcare facilities, performing different operations on the electronic medical record. Consider, for example, a scenario in which a patient named Bob visits an ophthalmologist and a dermatologist. The ophthalmologist verifies Bob's basic patient information, including his name and further enters some diagnostic results into Bob's existing electronic medical record. The entered information is locally stored. Later, Bob visits the dermatologist, where Bob's basic patient information is also verified. The dermatologist confuses Bob with another patient named John and therefore updates the name in Bob's electronic medical record to “John”. This results in conflicting information which is eventually detected when the electronic medical records, locally stored on computer systems of the ophthalmologist's and the dermatologist's office are synchronized to the central cloud repository.

Any editing of the electronic medical record by multiple parties has the potential for generating a conflict. However, many edits do not necessarily result in a conflict. For example, if one party edits the name, whereas the other party edits the date of birth, both changes can be accepted and automatically merged into an updated electronic medical record. Further any editing may be performed on local and/or cloud-based electronic medical records, without departing from the invention. Accordingly, the potential for a conflict may arise immediately, e.g., when a local or central electronic medical record is directly edited by two parties, or at a later time, e.g., when changes made to local copies of an electronic medical record a synchronized to a central (e.g. cloud-based) copy of the electronic medical record.

One or more embodiments of the invention provide conflict resolution for such scenarios. After the detection of the conflict, the parties that provided conflicting information may be notified and asked to provide information that identifies the correct electronic medical record data to be stored. Subsequently, the repository is updated with the electronic medical record data that were identified as correct, in accordance with one or more embodiments of the invention.

If, however, edits made by the parties can be merged into the electronic medical record without performing a conflict resolution, an automatic merge is performed to obtain an updated electronic medical record. While the conflict resolution may result in a delayed availability of the updated electronic medical record, the automatic merge may immediately generate the updated electronic medical record, without delay.

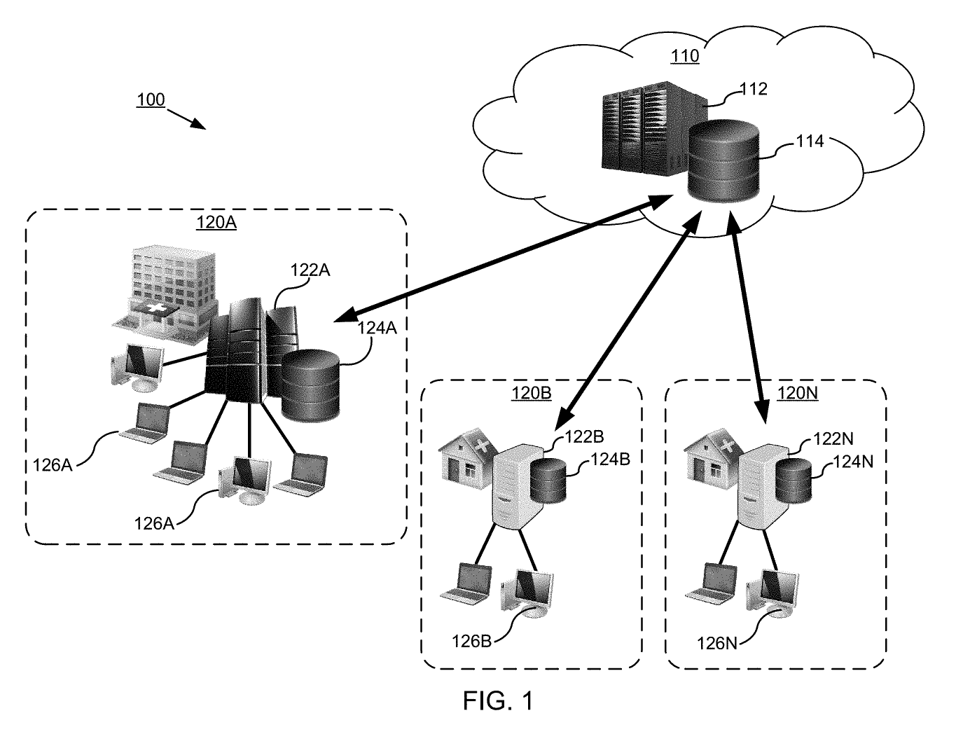

FIG. 1 shows a system (100) in accordance with one or more embodiments of the invention. The system (100) includes a cloud (110) that includes a cloud server (112) with a cloud repository (114). The system further includes multiple sites (120A-120N), in accordance with an embodiment of the invention. Each site may be a healthcare facility, e.g., a public or private hospital, a medical clinic, a dental clinic, a doctor's office, etc. Each site (120A-120N) may be equipped with a local server (122A-122N) (e.g., an application proxy server (APS)) and a local repository (124A-124N)). Each of the multiple local servers (122A-122N) may be authorized to access/view the cloud server (112). In addition to the right to access the remote data on the cloud server (112), certain local servers (122A-122N) may also have the right to edit the remote data.

As also shown in FIG. 1, each healthcare facility in the system (100) includes one or more user computing devices (126A-126N) (herein referred to as “a local computer”) coupled to the local servers (122A-122N). A local computer (126A-126N) may be a personal computer (PC), a laptop, a mobile computing device (e.g., tablet PC, smartphone, etc.), a server, a mainframe, a kiosk, etc.

In one or more embodiments of the invention, the cloud server (112) with the cloud repository (114) may be operated by a vendor providing the cloud-based PACS or another third-party associated with such a vendor. In one or more embodiments of the invention, the cloud server (112) is a physical and/or virtual computing infrastructure that performs application and information processing. For example, the cloud server (112) may be a virtual server or a physical server accessed remotely via the Internet. In one or more embodiments of the invention, the cloud repository (114) is an online repository of data. For example, the cloud repository may be a virtual data room (VDR) or a database (or group of databases) accessed remotely via the Internet. The cloud repository (114) stores multiple electronic medical records. The cloud repository (114) may be structured, for example, as directory, or it may be a database designed to accommodate a number of electronic medical records, for example in a PACS.

In one or more embodiments of the invention, the cloud server (112) is configured to receive the medical images and/or other data transmitted from the local servers (122A-122N) and store the medical images and/or other data in the cloud repository (114) as remote data.

In one or more embodiments of the invention, each local server (122A-122N) is operated by the associated healthcare facility. The local server (122A-122N) is configured to transmit the medical images and/or other data received from the local computers (126A-126N) to the cloud repository (114) on the cloud server (112). Each local repository (124A-124N) is operated and maintained by the associated healthcare facility. The local repository (124A-124N) may locally store medical images and/or other data received from the local server (122A) and the cloud repository (114).

In one or more embodiments of the invention, the local computers (126A-126N) are operated by medical professionals associated with the respective healthcare facilities and are configured to transmit to the local server (122A-122N) medical images and/or other data taken from one or more modalities (not shown) in the healthcare facility. In one or more embodiments of the invention, the local computers (126A-126N) may be configured as the local server (122A-122N). In one or more embodiments of the invention, one or more of the local computers (126A-126N) may also include the local repository (124A-124N).

In one or more embodiments of the invention, the local computers (126A-126N) are configured to store an application provided by the vendor that operates the cloud (110). In one or more embodiments of the invention, the application may be provided by a third-party associated with the vendor. The application may be an independent software application or a web-browser based application with a graphical user interface (“GUI”) that allows the local computers (126A-126N) to access the cloud (110).

In the exemplary system (100) shown in FIG. 1, the multiple in-network healthcare facilities (120A-120N) may communicate bilaterally with the cloud (110), in accordance with one or more embodiments of the invention. As shown in FIG. 1, the in-network healthcare facilities may transmit locally-obtained medical images and/or other data to the cloud (110) to be stored as remote data in the cloud repository (114) accessible to other in-network healthcare facilities. In one or more embodiments of the invention, the in-network healthcare facilities may retrieve medical images and/or other data from the cloud (110) to be stored as local data in their respective local repositories (124A-124N).

In one or more embodiments of the invention, not all of the remote data stored in the cloud repository (114) need be retrieved by the in-network healthcare facilities to be stored as local data. The remote data to be retrieved and stored as local data may vary based on the size and need of the healthcare facility or on the preferences of the local computers (126A-126N) (or on the preferences of the healthcare professionals using the local computers). For example, the remote data to be retrieved and stored as local data in the local repositories (124A-124N) of certain in-network healthcare facilities may be based on specific individuals who are patients of those facilities. Thus, if a particular individual is not a patient of a particular in-network healthcare facility, that healthcare facility may not retrieve and store that patient's medical images and/or other data from the cloud (110) as local data. This option may be particularly useful for smaller healthcare facilities with smaller local servers (122A-122N) and local repositories (124A-124N) with limited storage and processing power. In one or more embodiments of the invention, the remote data to be retrieved and stored as local data in the local repositories (124A-124N) of certain in-network healthcare facilities may be based on a specific medical study, medical series, medical image, or medical report instead of being based on specific individuals who are patients of those facilities.

In one or more embodiments of the invention, users of the local computers (126A-126N) at each in-network healthcare facility may view the medical images and/or other data stored on the cloud repository (114) through a web-browser based version of the application that is stored on the cloud server (112). The user may also view the images through a local version of the application stored on the local computers (126A-126N). For example, healthcare professionals may determine whether any of the local data stored in the local repository (124A-124N) have been updated by another healthcare professional associated with a different in-network healthcare facility, and retrieve the updated data from the cloud repository (1114) to replace the current local data. In one or more embodiments of the invention, the updating of the local data may be performed automatically by the system (100), e.g., through the application stored on the local computers (126A-126N).

For example, an individual may be a patient at multiple in-network healthcare facilities. Each of these in-network healthcare facilities may store the individual's medical images and/or other data as local data. In one or more embodiments of the invention, when the individual's medical images and/or other data are updated in the cloud repository (114) by one of the in-network healthcare facilities, the other in-network healthcare facilities where the individual is also a patient may automatically retrieve (synchronize) the individual's updated images and/or other data to keep the local data in the local repository (124A-124N) up-to-date. The automatic updating of the cloud repository (114) and/or synchronization of the pertinent local repositories (124A-124N) may be triggered every time the individual's medical images and/or other data are updated in the cloud, or may be triggered at predetermined intervals.

At times, the connection between one or more of the in-network healthcare facilities and the cloud (110) may get disconnected. In this state, the application may automatically configure the affected local computers (126A-126N) and local servers (122A-122N) at the disconnected healthcare facility to access the local data stored in the local repository (124A-124N). In one or more embodiments of the invention, the disconnected healthcare facility continues to store into the local repository (124A-124N) medical images and/or other data taken or updated during the time of disconnection. This enables the disconnected healthcare facility to establish a continuous workflow without experiencing any downtime caused by the disconnection from the cloud (110).

Then, when the connection between the disconnected healthcare facility and the cloud (110) is reestablished, the local computers (126A-126N) and local servers (122A-122N) of the reconnected healthcare facility may be configured by the application to transmit to the cloud (110) all of the medical images and/or other data stored in the local repository captured or updated during the time of disconnection. Such medical images and/or other data may then be stored in the cloud repository (114) as new remote data. As the cloud (110) is being updated with the medical images and/or other data from the reconnected healthcare facility, the application stored in the local computers (1126A-126N) of the other in-network facilities may automatically update their respective local repositories (124A-124N) with the new remote data.

One skilled in the art will recognize that the architecture of the system (100) is not limited to the components shown in FIG. 1. For example, the server (112) and the repository (114) are not necessarily cloud-based. Instead, the cloud server (112) and the cloud repository (114) may be any type of central server and central repository, respectively. For example, a healthcare provider network may maintain its own server(s) and repository(-ies) and they may or may not be cloud-based. Further, the system (100) may include any number of sites (120A-120N) of any size and type, without departing from the invention. Also, a system in accordance with an embodiment of the invention may operate completely without a central server. Such a system may include a number of local repositories, or even a single local repository only.

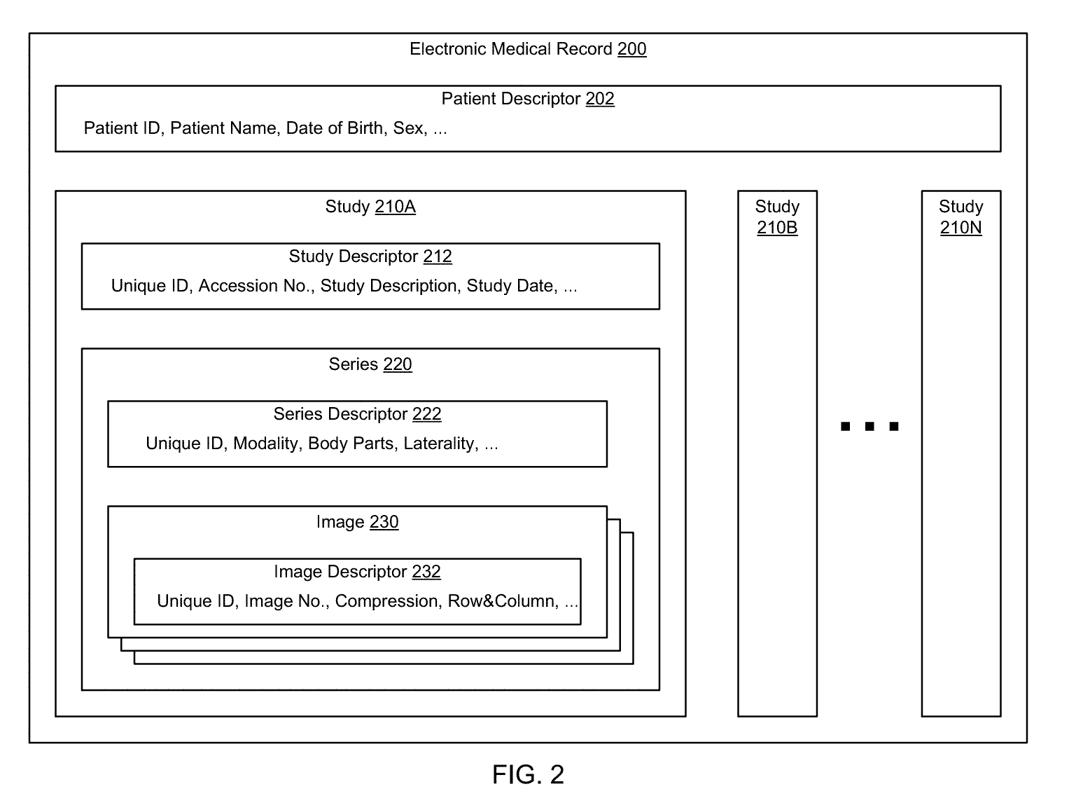

FIG. 2 shows an exemplary electronic medical record in accordance with one or more embodiments of the invention. Such an electronic medical record may be stored in the cloud repository and/or in one or more local repositories. The exemplary electronic medical record may, thus, be a central or a local electronic medical record. In one embodiment of the invention, the electronic medical record is specific to a particular patient and includes at least a patient descriptor (202) and one or more studies (210A-210N). These elements are subsequently described.

In one or more embodiments of the invention, the patient descriptor (202) includes basic patient information or patient demographics such as sex, age and address, etc. The patient descriptor further includes a patient ID that is unique to the patient. The patient descriptor (202) may further include any other type of information that is related to the patient, and that is not necessarily specific to a study (210A-210N).

In one or more embodiments of the invention, a patient study includes information that is related to a patient concern or a patient issue, such as, for example, a sore throat or a bone fracture. To understand and/or address the patient concern/issue, diagnostic and/or therapeutic actions may be performed. For example, diagnostic images may be taken. These images may be stored in series, as further described below.

Those skilled in the art will recognize that, even though the exemplary medical record of FIG. 2 illustrates the storage of images only, other medical data associated with diagnostic and/or therapeutic actions may be stored in an electronic medical record, without departing from the invention. The following list provides a non-limiting set of exemplary studies that may be performed on a patient:
Physical examination—Exploration and observation of the patient's body, typically including auscultation, palpation, manipulation, probing and results of sensory and motor tasks performed by the patient.
Laboratory tests—Chemical, microscopic and microbiological analyses of readily obtained specimens such as blood, urine, saliva, sputum, feces, etc. These may be processed on-site or sent to diagnostic laboratories.
Medical imaging—Use of specialized equipment to obtain planar or 3D representations of the physical tissues of the body such as by X-ray, computed tomography (CT), magnetic resonance imaging (MRI), ultrasound (US), positron emission tomography (PET), impedance tomography, radioisotope imaging, etc. These usually require sending the patient to an imaging machine.
Electrophysiology—Use of specialized instruments to measure electrical signals associated with physiological functions such as electrocardiography (ECG), electroencephalography (EEG), electromyography (EMG), etc. These usually require sending the patient to the instrumentation.
Functional tests (Various physiological functions can be assessed by making various specialized measurements while the patient performs a specific task such as rapid walking, deep breathing, micturition, etc.) These usually require sending the patient to a specialized laboratory.

Each of the above exemplary actions may be performed on a patient for diagnostic and/or therapeutic purposes. Each action may then be documented in the electronic health record as a study (210A-210N).

A study (210A-210N), in accordance with an embodiment of the invention, includes, for example, a description of the diagnostic/therapeutic action, and action results. Depending on the type of the action that was performed, the documentation included in the study may vary, without departing from the invention.

The exemplary study (210A), illustrated in FIG. 2, includes a documentation of an imaging method that was performed on the patient. Assume for example, that a patient arrives in the emergency room with a hip fracture. To properly diagnose the hip fracture, a series of X-ray images is taken. Later additional series of images may be taken to assess the healing process.

A study, in accordance with an embodiment of the invention, includes a study descriptor (212) and one or more series (220). The study descriptor (212) includes descriptive data of the study that is/was performed. The study descriptor may serve administrative purposes and may further enable physicians or other healthcare professionals to obtain information that is related to the study. The study descriptor (212), in one embodiment of the invention, includes a unique identifier (ID), an accession number, a study description and/or a study date. Those skilled in the art will appreciate that the study descriptor (212) may further include any other type of study-related descriptive data.

In one embodiment of the invention, the unique ID serves as a unique identifier of the study. The unique ID may be, for example, an alphanumeric expression that may have been randomly or systematically created. The unique ID may further include the name of the physician or the nurse conducting the study, or any other information that is pertinent to the study.

In one embodiment of the invention, the accession number serves as an identifier of the study. The accession number may be generated at the time when the study is performed or when the study is documented in the electronic medical record. The accession number may be a decimal number, an alphanumerical code, or any other type of identifier suitable for identifying the study.

The study description may provide a general description of the study being performed. In the example of the previously described patient with a hip fracture, the study description may state “hip fracture” without necessarily specifying details regarding the imaging to be performed or having been performed, to properly diagnose the hip fracture. The study date may be the date when the study is/was ordered, when the study is/was executed, when a particular series of a study is/was executed, etc.

As previously noted, a study, in accordance with one or more embodiments of the invention, includes one or more series (220). In the previously introduced example of the patient with the hip fracture, multiple series may be generated over time. For example, an initial series of X-ray images may be generated to diagnose the hip fracture. Multiple additional studies may be generated at later times, e.g., to assess the healing progress.

The series (220), in one embodiment of the invention, includes the series descriptor (222) and one or more images (230). The series descriptor (222) may include any type of data that may be used to document the images (230). For example, the series descriptor may include a modality (e.g., stating that an X-ray or a CT image was taken), body parts that are being imaged, the laterality (providing imaging location information), etc. The series descriptor may further include a unique ID (as previously described). The unique ID associated with the series may differ from the unique ID that identifies the study.

The one or more images (230) may be any type of medical image. In the example of the patient with the hip fracture, the images may be X-ray or CT images. These images may be stored in any format including formats that are commonly used in healthcare, e.g., using the DICOM standard, and/or using any other image format, including commonly used compressed or uncompressed formats such as TIFF, JPEG, etc.

In one embodiment of the invention, an image (230) is accompanied by an image descriptor (232). The image descriptor provides information specific to the image, such as a unique ID, an image number, information regarding image compression, row & column information, the date when the picture was taken, etc.

Although FIG. 2 describes the storage of patient data in the form of a patient medical record, patient data may be stored in other forms, without departing from the invention. For example, in a picture archiving and communication system (PACS), no complete electronic medical record may exist. Further, embodiments of the invention are equally suitable for storing non-imaging data in addition to or as an alternative to imaging data. Further, if the system stores patient data using electronic medical records, it may include additional sections, such as fields for documenting clinical actions and the results thereof. These results may include diagnostic information which may be encoded using, for example, the frequently used International Classification of Diseases (ICD), including ICD-9 or ICD-10. In addition, any data in an electronic medical record may be stored in either encrypted or unencrypted form.

In the subsequent discussion of electronic medical records, the term “electronic medical record data” is used for any data entry in an electronic medical record. Such a data entry may be an image or any other piece of information, including for example, patient information such as the patient's name, a diagnosis, etc. The totality of all electronic medical record data in a patient electronic medical record forms the patient's medical history. Electronic medical record data may be written to or read from a data field of an electronic medical record. If the electronic medical record data includes multiple elements (e.g., an image, and elements of a series descriptor), each of these elements is written to/read from a separate data field (i.e., there is one data field for the image, and one data field for each element of the series descriptor).

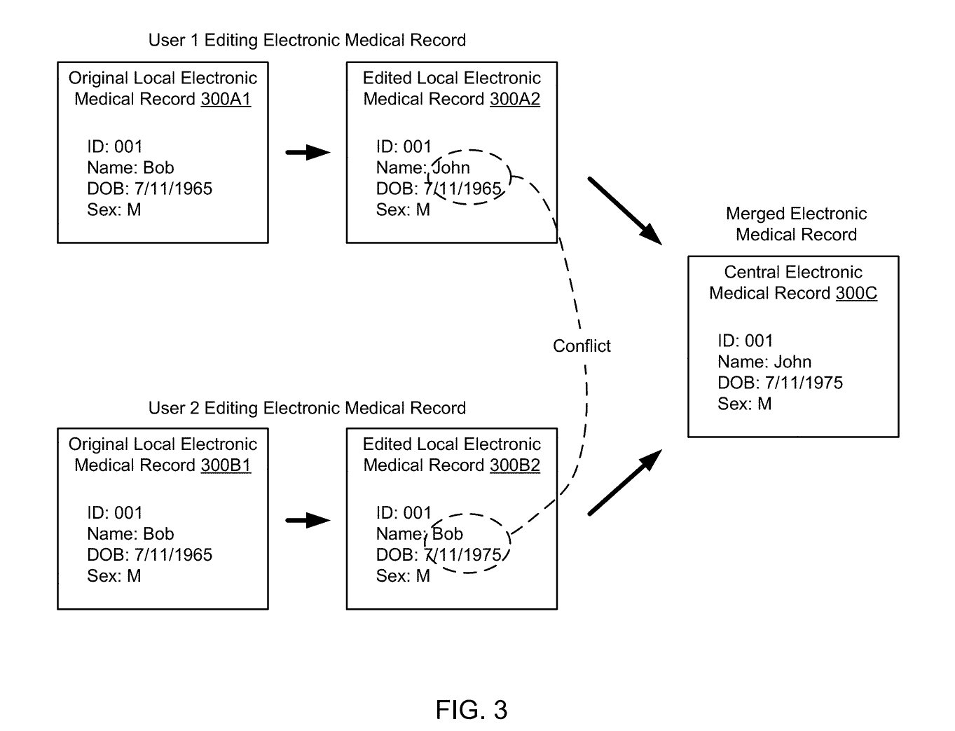

FIG. 3 shows an exemplary scenario that includes conflicting electronic medical record data, in accordance with one or more embodiments of the invention.

Consider a system (100), in which many electronic medical records are centrally stored in the cloud repository (114) of the cloud server (112). Each of the electronic medical records is uniquely associated with a patient. Further, assume that the electronic medical record of one particular patient is shared with two sites (120A, 120B), for example, because the patient visited both sites. Accordingly, the central electronic medical record (300C) is obtained by both sites (300A, 300B), and is stored in the local repositories (124A, 124B) as local electronic medical records (300A1, 300B1). Unless the local electronic medical records (300A1-300B1) are edited, e.g., by physician via the local computers (126A-126B), the local electronic medical records (300A1, 300B1) are identical to the corresponding central electronic medical record (300C).

Now assume that two parties, user 1 and user 2, are accessing this electronic medical record. Prior to the users making changes to the local copies, they are identical to the central medical record (300C), stored in the cloud repository (114). These local copies are, thus, termed “original local electronic medical records” (300A1, 300B1). The original local electronic medical record (300A1) is now edited by user 1, e.g., by a physician, who updates the name of the patient from “Bob” to “John”, thus resulting in an edited local electronic medical record (300A2). The edited local electronic medical record (300A2) is, thus, no longer identical to the central electronic medical record (300C). To ensure that the changes made to the local electronic medical record (300A2) are available across the system (100), a synchronization of the central electronic medical record (300C) with the local electronic medical (300A2A) is necessary.

Further, the original local electronic medical record (300B1) is edited by user 2, e.g., by a physician, who updates the date of birth of the patient, thus resulting in an edited local electronic medical record (300B2). The edited local electronic medical record (300B2) is, thus, also no longer identical to the central electronic medical record (300C). To ensure that the changes made to the local electronic medical record (300B2) are available across the system (100), a synchronization of the central electronic medical record (300C) with the local electronic medical (300A2A) is necessary.

The synchronization of the central electronic medical record (300C) using the information from the edited local electronic medical record (300A2) and from the edited local electronic medical record (300B2) results in an automatic merge of the local electronic medical records (300A2, 300B2) to form an updated electronic medical record that is stored as the central electronic medical record (300C).

In one or more embodiments of the invention, a synchronization operation may occur at any time. More specifically, the synchronization of a central electronic medical record with the corresponding local electronic medical record, e.g., after the local electronic medical record has been edited, may occur at scheduled intervals, e.g., every hour or at a particular time of day, etc. The synchronization may further occur in a load-dependent manner, e.g., when system load is low. Alternatively or additionally, synchronization may occur when a trigger event is detected. Such a trigger event may be, the detection of the editing of the local electronic medical record, the detection of a discrepancy between content of the local electronic medical record and the corresponding central electronic medical record, the detection of a data connection between the site with the local electronic medical record and the cloud (e.g., when this data connection is restored after an interruption), and/or the detection of a synchronization request submitted by a user, e.g., a clinician accessing the local electronic medical record using a local computer.

In one or more embodiments of the invention, a synchronization operation may be performed for an entire electronic medical record, or for one or more elements of the electronic medical record. In the above-described example of the synchronization shown in FIG. 3, only the patient's name may be updated during the synchronization, or alternatively, the entire electronic medical record, or sections of the electronic medical record may be updated.

While the exemplary scenario of FIG. 3 illustrates the updating of a central electronic medical record, e.g., a cloud based electronic medical record, the updated electronic medical record may alternatively be located in a local repository, without departing from the invention. Similar updating of an electronic medical record may be performed regardless of whether the electronic medical record is purely cloud based, cloud based with local copies, or purely local.

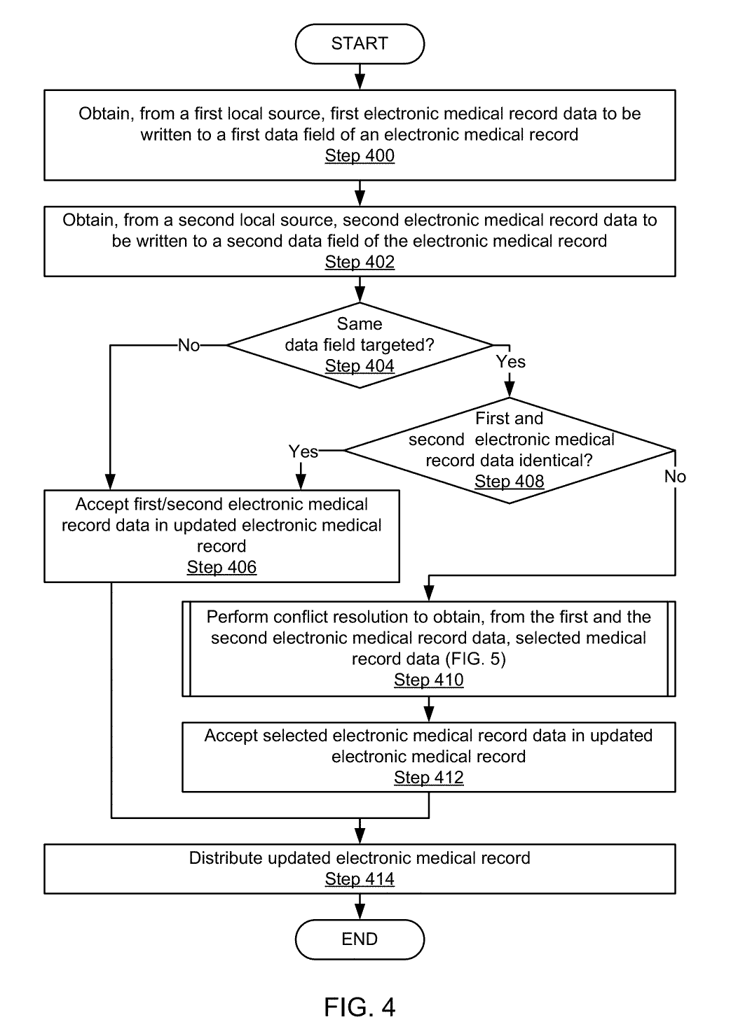

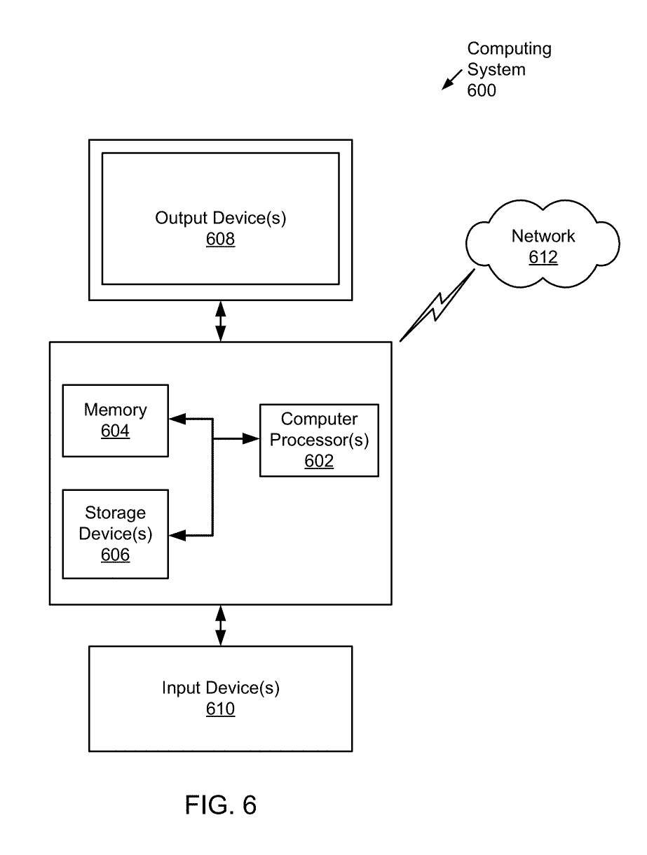

FIG. 4 shows a flowchart in accordance with one or more embodiments of the invention. The process depicted in FIG. 4 may be used for storing non-conflicting and conflicting data encountered during synchronization of electronic medical records, in accordance with one or more embodiments of the invention. One or more of the steps in FIG. 4 may be performed by the components of the system (100), discussed above in reference to FIG. 1. In one embodiment of the invention, the steps shown in FIG. 4 may be performed by a conflict resolution engine (not shown), executing on a computing device, e.g., the cloud server (112) which may be similar to the computing device of FIG. 6. The conflict resolution engine may thus include software instructions that implement the method shown in FIG. 4. One or more of the steps shown in FIG. 4 may be executed whenever electronic medical record data in a local or a central repository are updated. While the flowchart describes the handling of conflicting data provided by two sources, those skilled in the art will recognize that conflicting data may be obtained from any number of sources, without departing from the invention.

In one or more embodiments of the invention, one or more of the steps shown in FIG. 4 may be omitted, repeated, and/or performed in a different order than the order shown in FIG. 4. Accordingly, the scope of the invention should not be considered limited to the specific arrangement of steps shown in FIG. 4.

In Step 400, electronic medical record data are obtained from a first local source. The first local source may be a first user entering data into an electronic medical record or it may be a local electronic medical record to be synchronized to a central medical record. The obtained electronic medical record data may be a complete locally stored electronic medical record of a patient, or alternatively it may be one or more elements of an electronic medical record. The obtained electronic medical record data, in one embodiment of the invention, originates from the central medical record, but has been edited by the first user. The electronic medical record data may be spontaneously obtained, e.g., as the first user is entering the electronic medical record data into the electronic medical record. Alternatively, the electronic medical record data may be obtained upon occurrence of a trigger event, such as a local user requesting the synchronization of the electronic medical data to a central repository, or after a previously defined time interval has expired (e.g., in a system that is configured to perform a periodic synchronization between repositories). Alternatively, the electronic medical record data may be obtained by the cloud server querying the local server that interfaces with the local repository for the electronic medical record.

In Step 402, electronic medical record data are obtained from a second local source, different from the first local source. Analogous to the first local source, the second local source may also be a user or a locally stored electronic medical record. The obtained electronic medical record data, in one embodiment of the invention, originates from the central medical record, but has been edited by a second user. In one embodiment of the invention, the electronic medical record data obtained from the first and the second local source are for the same patient and relate to the same data field(s) or different data fields of the patient's electronic medical record. Steps 400 and 402 may be performed at any time. Specifically, Steps 400 and 402 may be executed concurrently or sequentially.

In Step 404, a determination is made about whether the first and the second electronic medical record data target the same data field(s) of the electronic medical record. The determination may be made based on a comparison of the electronic medical record prior to and after the writing of the first and the second electronic medical record data. This comparison may show the data fields that were affected by the writing of the first and second electronic medical record data, respectively. If a determination is made that different data fields are targeted by the operation, or in other words, the first and the second data fields are different, the method may proceed with the execution of Step 406. If, however, the first and the second data fields are identical, the method may instead proceed with the execution of Step 408.

In Step 406, the first and the second electronic medical record data are written to the first and the second data fields, respectively, of the electronic medical record. In other words, the first and the second electronic medical record data are automatically merged into the electronic medical record, resulting in an updated electronic medical record.

Returning to Step 404, if a determination is made that the first and the second data fields are identical, the method may proceed to Step 408, in which a determination is made about whether the first and the second electronic medical record data are identical. If the first and the second electronic medical record data are found to be identical, the method may proceed to Step 406, in which, because the data are identical, either the first or the second electronic medical record data are written to the targeted data field.

Returning to Step 408, if a determination is made that the first and the second electronic medical record data are different, the method may proceed to Step 410.

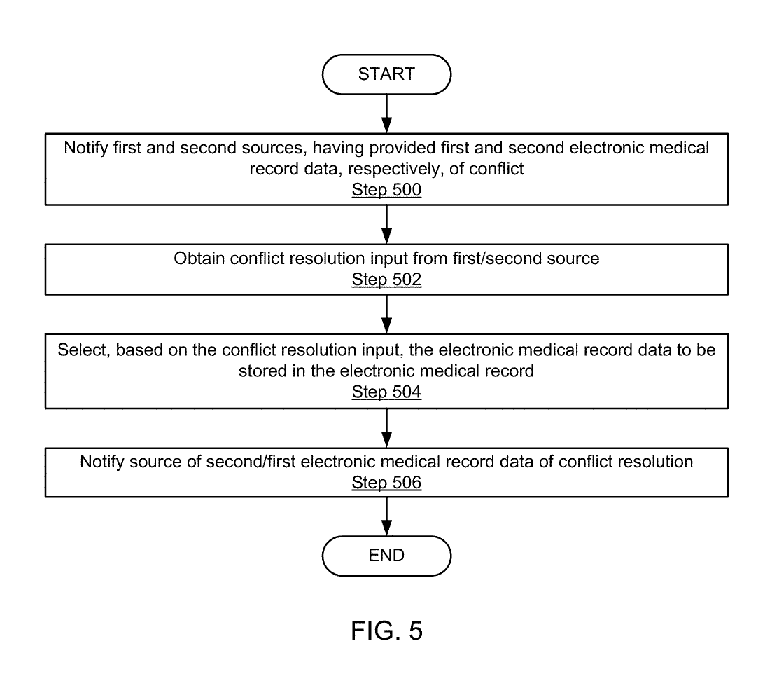

In Step 410, a conflict resolution is performed to enable a decision regarding whether the first or the second electronic medical record data are to be written to the electronic medical record. The conflict resolution, in accordance with an embodiment of the invention, identifies the medical record data selected for storage. The details regarding the conflict resolution are described in FIG. 5.

In Step 412, the selected electronic medical record data are written to the electronic medical record to obtain an updated electronic medical record.

In Step 414, once the electronic medical record data have been stored in the updated electronic medical record, the updated electronic medical record may be distributed to other locations, e.g., to a cloud repository. For example, if the updated electronic medical record is locally stored, it may be synchronized to a central location, from where it can be distributed to other locations.

Those skilled in the art will appreciate that the time intervals between the various steps during the execution of the method shown in FIG. 4 may vary. As previously noted, obtaining the first and the second electronic medical record data may happen simultaneously or sequentially. Further, the conflict may be detected immediately after the second electronic medical record data were received, or alternatively, at a later time, e.g., if the comparison of the first and the second electronic medical record data is not immediately performed. This may be the case in a system in which the updating of the central repository is performed based on a fixed schedule.

FIG. 5 shows a flowchart illustrating a method for performing a conflict resolution in accordance with one or more embodiments of the invention.

In Step 500, the first and the second sources, having provided the first and the second electronic medical record data, respectively, are notified of the conflict. The notified sources may be the users having entered the conflicting first and second electronic medical record data. The notification may be, for example, an email message, a popup window, a text message sent to, e.g., a portable device, or any other type of message suitable for communicating the conflict. A notification may alternatively or additionally be sent to a third party, e.g., a person that is dedicated to conflict resolution. Because there may be a delay between the first and the second users entering the conflicting electronic medical record data and the conflict detection, the conflict notification may also not be immediately delivered to the users after the entering of the conflicting electronic medical record data.

In Step 502, a conflict resolution input is obtained from one of the parties that were contacted in Step 500. For example, the user who entered the second electronic medical record data may respond to the notification. The response may be provided in various ways. If the notification was provided in a popup window, the popup window may show the two conflicting versions of the electronic medical record data, and may further allow the users to select the version to be stored in the electronic medical record. Alternatively, a user responding to the conflict notification may return to the interface, e.g., a web client, used for entering the electronic medical record data, to confirm or edit the entered electronic medical record data.

In Step 504, based on the conflict resolution input obtained in Step 502, the electronic medical record data to be stored in the electronic medical record is selected.

In Step 506, the other parties are notified of the selected electronic medical record data to be stored in the electronic medical record. For example, assuming that in Step 502, a conflict resolution input was obtained from the second user, the first user is notified regarding the second user's selection. The notification may be provided, for example, as a popup window or as an email or text message. Alternatively, an editing history may document the electronic medical record data that were selected and/or the electronic medical record data that were not selected. This editing history may be accessible by a group of users, including the first and the second users. If an editing history is used for the notification, the sending of a notification to the user may be unnecessary.

FIG. 6 shows a computing system in accordance with one or more embodiments of the invention. Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 6, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor. The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (600) may be located at a remote location and connected to the other elements over a network (612). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

Various embodiments of the invention have one or more of the following advantages. The availability of a mechanism for conflict resolution enables the automatic merging of medical record data, when possible. The automatic merging results in an updated electronic medical record suitable for immediate distribution, e.g. using synchronization, across an entire network. Updated data may therefore become available almost instantaneously after the data have been entered. Due to the availability of a conflict resolution, no locking of a medical record is necessary when one party edits an electronic medical record, and a second party may therefore simultaneously edit the electronic medical record. The methods for automatic merging and conflict resolution, in combination with local servers, in addition to a cloud server, may improve the accessibility of electronic medical records. These local servers may store copies of the electronic medical records that are centrally stored on the cloud server. The automatic merging and conflict resolution, in accordance with one or more embodiments of the invention ensures that synchronization between locally and centrally stored electronic medical records is maintained, even in case of a conflict. Accordingly, users may access a local copy of an electronic medical record, rather than the copy on the cloud server, thus minimizing latencies and increasing availability, e.g., when a network connection between the cloud server and one or more of the local servers is interrupted.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for storing data during an update of an electronic medical record, comprising:
obtaining, from a first source, first electronic medical record data to be written to a first data field of the electronic medical record;
obtaining, from a second source, second electronic medical record data to be written to a second data field of the electronic medical record;
making a first determination that different data fields of the electronic medical record are targeted by the first and the second sources, and based on the first determination:
accepting the first and the second electronic medical record data in the first and the second data fields, respectively, of the electronic medical record to obtain a first updated electronic medical record.

2. The method of claim 1, further comprising:
obtaining, from a third source, third electronic medical record data to be written to a third data field of the electronic medical record;
obtaining, from a fourth source, third electronic medical record data to be written to the third data field of the electronic medical record;
making a second determination that the same data field of the electronic medical record is targeted by the third and the fourth sources;
making a third determination that the electronic medical record data obtained from the third and the fourth sources are identical, and based on the second and third determinations:
accepting the third electronic medical record data in the third data field of the electronic medical record to obtain a second updated electronic medical record.

3. The method of claim 1, further comprising:
obtaining, from a third source, third electronic medical record data to be written to a third data field of the electronic medical record;
obtaining, from a fourth source, fourth electronic medical record data to be written to the third data field of the electronic medical record;
making a second determination that the same data field of the electronic medical record is targeted by the third and the fourth sources;
making a third determination that the electronic medical record data obtained from the third and the fourth sources are different, and based on the second and third determinations, performing a conflict resolution, comprising:
notifying the first and the second source of the conflict;
obtaining a conflict resolution input from the first source,
wherein the conflict resolution input identifies one of the first and the second electronic medical record data as the medical record data selected for storage in the third data field of the electronic medical record;
notifying the second user regarding the conflict resolution; and
accepting the electronic medical record data selected for storage in the third data field of the electronic medical record to obtain a second updated electronic medical record.

4. The method of claim 1, further comprising synchronizing other copies of the electronic medical record with the first updated electronic medical record.

5. The method of claim 4, wherein at least one of the other copies of the electronic medical record is located in a local repository.

6. The method of claim 4, wherein at least one of the other copies of the electronic medical record is located in a central repository that is synchronized with local repositories.

7. The method of claim 6, wherein the central repository is cloud-based.

8. The method of claim 1, wherein the first source is a user entering data into the electronic medical record.

9. The method of claim 1,
wherein the first source is a first local repository comprising a first copy of the electronic medical record,
wherein the second source is a second local repository comprising a second copy of the electronic medical record, and
wherein the first updated electronic medical record is stored in a central repository.

10. The method of claim 1, wherein the first electronic medical record data comprise at least one selected from a group consisting of patient demographic data and an element of the patient medical history.

11. A non-transitory computer-readable medium (CRM) storing instructions that cause a computing system to perform an operation to store data during an update of an electronic medical record, comprising:
obtaining, from a first source, first electronic medical record data to be written to a first data field of the electronic medical record;
obtaining, from a second source, second electronic medical record data to be written to a second data field of the electronic medical record;
making a first determination that different data fields of the electronic medical record are targeted by the first and the second sources, and based on the first determination:
accepting the first and the second electronic medical record data in the first and the second data fields, respectively, of the electronic medical record to obtain a first updated electronic medical record.

12. The non-transitory CRM of claim 11, further storing instructions that cause the computing system to perform an operation comprising:
obtaining, from a third source, third electronic medical record data to be written to a third data field of the electronic medical record;
obtaining, from a fourth source, third electronic medical record data to be written to the third data field of the electronic medical record;
making a second determination that the same data field of the electronic medical record is targeted by the third and the fourth sources;
making a third determination that the electronic medical record data obtained from the third and the fourth sources are identical, and based on the second and third determinations:
accepting the third electronic medical record data in the third data field of the electronic medical record to obtain a second updated electronic medical record.

13. The non-transitory CRM of claim 11, further storing instructions that cause the computing system to perform an operation comprising:
obtaining, from a third source, third electronic medical record data to be written to a third data field of the electronic medical record;
obtaining, from a fourth source, fourth electronic medical record data to be written to the third data field of the electronic medical record;
making a second determination that the same data field of the electronic medical record is targeted by the third and the fourth sources;
making a third determination that the electronic medical record data obtained from the third and the fourth sources are different, and based on the second and third determinations, performing a conflict resolution, comprising:
notifying the first and the second source of the conflict;
obtaining a conflict resolution input from the first source,
wherein the conflict resolution input identifies one of the first and the second electronic medical record data as the medical record data selected for storage in the third data field of the electronic medical record;
notifying the second user regarding the conflict resolution; and
accepting the electronic medical record data selected for storage in the third data field of the electronic medical record to obtain a second updated electronic medical record.

14. The non-transitory CRM of claim 11, further storing instructions that cause the computing system to perform an operation comprising synchronizing other copies of the electronic medical record with the first updated electronic medical record.

15. The non-transitory CRM of claim 14, wherein at least one of the other copies of the electronic medical record is located in a central repository that is synchronized with local repositories.

16. A computing system that stores data during an update of an electronic medial record, the computing system comprising:
a central server; and
a central repository associated with the central server,
wherein the central server:
obtains, from a first source, first electronic medical record data to be written to a first data field of the electronic medical record;
obtains, from a second source, second electronic medical record data to be written to a second data field of the electronic medical record;
makes a first determination that different data fields of the electronic medical record are targeted by the first and the second sources, and based on the first determination:
accepts the first and the second electronic medical record data in the first and the second data fields, respectively, of the electronic medical record to obtain a first updated electronic medical record.

17. The computing system of claim 16, wherein the central server further:
obtains, from a third source, third electronic medical record data to be written to a third data field of the electronic medical record;
obtains, from a fourth source, third electronic medical record data to be written to the third data field of the electronic medical record;
makes a second determination that the same data field of the electronic medical record is targeted by the third and the fourth sources;
makes a third determination that the electronic medical record data obtained from the third and the fourth sources are identical, and based on the second and third determinations:
accepts the third electronic medical record data in the third data field of the electronic medical record to obtain a second updated electronic medical record.

18. The computing system of claim 16, wherein the central server further:
obtains, from a third source, third electronic medical record data to be written to a third data field of the electronic medical record;
obtains, from a fourth source, fourth electronic medical record data to be written to the third data field of the electronic medical record;
makes a second determination that the same data field of the electronic medical record is targeted by the third and the fourth sources;
makes a third determination that the electronic medical record data obtained from the third and the fourth sources are different, and based on the second and third determinations, performs a conflict resolution, comprising:
notifying the first and the second source of the conflict;
obtaining a conflict resolution input from the first source,
wherein the conflict resolution input identifies one of the first and the second electronic medical record data as the medical record data selected for storage in the third data field of the electronic medical record;
notifying the second user regarding the conflict resolution; and
accepts the electronic medical record data selected for storage in the third data field of the electronic medical record to obtain a second updated electronic medical record.

19. The computing system of claim 16, wherein the central server further synchronizes other copies of the electronic medical record with the first updated electronic medical record.

20. The computing system of claim 19, wherein at least one of the other copies of the electronic medical record is located in a central repository that is synchronized with local repositories.
